(19) United States
(12) Patent Application Publication
(10) Pub. No.: US 2026/0121146 A1
(43) Pub. Date: Apr. 30, 2026

(54) METHOD FOR PRODUCING A LITHIUM-CONTAINING ELECTRODE, AND ELECTROCHEMICAL CELL

(71) Applicant: Siemens Aktiengesellschaft, München (DE)

(72) Inventors: Jens Dahl Jensen, Berlin (DE); Ursus Krüger, Berlin (DE); Gabriele Winkler, Berlin (DE)

(21) Appl. No.: 19/480,271

(22) PCT Filed: Mar. 19, 2024
(86) PCT No.: PCT/EP2024/057263

§ 371 Date: Oct. 30, 2025

(30) Foreign Application Priority Data
May 2, 2023 (EP) 23171092.2

(51) Int. Cl. H01M 10/54; H01M 4/02; H01M 4/131; H01M 4/133; H01M 4/1391; H01M 4/1393; H01M 4/485; H01M 4/587; H01M 4/62; H01M 4/66; H01M 4/70; H01M 10/0525

(52) U.S. Cl. CPC H01M 10/54; H01M 4/131; H01M 4/133; H01M 4/1391; H01M 4/1393; H01M 4/485; H01M 4/587; H01M 4/622; H01M 4/625; H01M 4/661; H01M 4/70; H01M 10/0525; H01M 2004/027; H01M 2004/028

(57) ABSTRACT

A method for producing a lithium-containing electrode for a lithium-ion containing accumulator is provided, including:—producing a metal foil;—coating a surface of the metal foil with a graphite layer;—introducing the metal foil into an electrochemical cell as a first electrode, which is used as a cathode;—introducing a second, lithium-containing electrode into the cell used as an anode;—wherein lithium compounds are introduced into the second electrode, the lithium compounds originating from thermally decomposed electrode material of a lithium-ion accumulator;—introducing a non-aqueous electrolyte into the cell;—closing the cell under inert conditions;—applying an electrical current to the electrodes of the cell such that lithium ions migrate from the lithium-containing anode to the cathode in the form of the metal foil provided with the graphite layer, through the non-aqueous electrolyte; and—the surface of the metal foil is intercalated to form lithium ions.

### CROSS-REFERENCE TO RELATED APPLICATIONS

This application is a national stage of PCT Application No. PCT/EP2024/057263, having a filing date of Mar. 19, 2024, which claims priority to EP Application No. 23171092.2, having a filing date of May 2, 2023, the entire contents both of which are hereby incorporated by reference.

### FIELD OF TECHNOLOGY

The following relates to a method for producing a lithium-containing electrode and to an electrochemical cell.

### BACKGROUND

Valuable metals such as nickel, cobalt and lithium are recovered from lithium-ion accumulators after the cells have been processed, i.e., after electrical safety discharge, deactivation of the remaining lithium metal and evaporation of the electrolytes by a pyro- and hydrometallurgical process. The pyrometallurgical process produces not only the cobalt-nickel-copper alloys but also lithium-containing slag. The lithium present in this lithium-containing slag is to be recycled therefrom.

According to the prior art, this lithium is recovered from the slag by hydrometallurgical processes. The quenched slag is crushed by rod mills and then transferred via a magnetic disk in order to remove ferromagnetic alloy constituents trapped in the slag, such as nickel and cobalt. The slag is then leached with sulfuric acid. The lithium ions dissolve here, and the remaining solids, which include gypsum and silicates, are separated off by filtration. In order to prevent unwanted precipitation of lithium carbonate in subsequent cleaning steps, the filtrate is diluted below the solubility limit of lithium carbonate. The diluted filtrate is adjusted to a pH of 7 by adding calcium oxide in order to remove impurities such as aluminum, magnesium, iron, manganese, silicon and sulfate. At this pH, aluminum, iron and silicon precipitate out as hydroxides, as do some heavy metals. A portion of the sulfate forms sparingly soluble calcium sulfate (gypsum) with the calcium oxide. After separation of solids/liquids, the pH is raised to 12 by further addition of calcium oxide. At this pH, magnesium and further metals that are present in the solution as hydroxides or sulfate residues are fully precipitated. After further separation of solids/liquids, excess calcium is precipitated as lime by adding sodium carbonate and separated from the solution by filtration. The solution is highly concentrated by evaporation of the water, and the lithium is precipitated as lithium carbonate by adding sodium carbonate at 100° C. The lithium carbonate that has been separated off is washed with ethanol because lithium carbonate is insoluble in ethanol, by contrast with water. The purity of this crude carbonate is about 98% and requires repeated refining for reuse in batteries. With this method according to the prior art, the total yield of lithium, i.e., the yield from the slag, is about 65%. The reason for this low yield is that some of the lithium is incorporated into the mixed metal oxides with aluminum, magnesium, iron or manganese when the impurities are precipitated with calcium oxide. This lithium is chemically bound so tightly that it would have to be separated from the starting solution by a solvent extraction process in order to significantly increase the yield.

This described method according to the prior art shows the very high wet-chemical complexity, which is both economically and environmentally unviable.

### SUMMARY

An aspect relates to a method and an electrochemical cell that serves for reutilizing lithium, whereby a higher yield than in the prior art is achieved and at the same time reutilizing the recovered lithium in a new electrode is rendered possible.

An aspect relates to a method for producing a lithium-containing electrode and by an electrochemical cell.

In embodiments, the method for producing a lithium-containing electrode for a lithium ion-containing accumulator comprises the following steps:
producing a metal foil;
coating a surface of the metal foil with a graphite layer;
introducing the metal foil provided with the graphite layer into an electrochemical cell as a first electrode, which serves as a cathode; and
introducing a second, lithium-containing electrode into the cell, the second, lithium-containing electrode serving as an anode,
wherein lithium compounds are introduced into the second, lithium-containing electrode, the lithium compounds originating from decomposed (in particular thermally decomposed) electrode material of a lithium-ion accumulator,
introducing a nonaqueous electrolyte into the electrochemical cell;
closing the electrochemical cell under inert conditions;
applying electric current to the electrodes of the electrochemical cell, so that lithium ions migrate from the lithium-containing anode to the cathode in the form of the metal foil with the graphite layer, through the nonaqueous electrolyte; and
the graphite layer of the metal foil is intercalated with lithium ions.

Embodiments of the invention thus described fundamentally differ from the prior art in that the slag that is typically obtained from a thermal breakdown of accumulators and contains lithium compounds is not digested by wet-chemical means but is implanted again into an electrode and into an electrochemical cell. In turn, in embodiments, the method differs from a conventional electrochemical cell and a conventional lithium-ion accumulator in that the lithium ions migrate from the electrode with the lithium slag via an electrolyte to the cathode and are intercalated in a specially provided layer, specifically in a graphite layer.

Intercalation is understood to mean the insertion of molecules or ions (possibly also atoms) into chemical compounds, these not substantially changing their structure during the insertion process. In this special case, the lithium ions are positioned between the individual graphene layers of the graphite since only the weak van der Waals forces have to be overcome between the graphene layers for insertion (intercalation).

Furthermore, in embodiments, the method described also differs from the prior art in that the cathode in this electrochemical cell or in this performed method is configured such that the electrically conductive metal foil is provided with the graphite-containing layer into which the lithium ions are intercalated, and during embodiments of the method a new electrode is created in turn. This new electrode is already configured by its structuring of the surface and its surface coating as an electrode for a new lithium-ion accumulator in this case, for example in the form of an anode(in the case of an accumulator (battery), the positively charged electrode during the discharge process is referred to as the cathode and the negatively charged electrode is referred to as the anode).

In embodiments, the method described not only offers a technically less complex and economical way of reutilizing the lithium-containing slag obtained in the breakdown, in particular the thermal breakdown, of old accumulators but at the same time provides a production method for a completely new, directly reusable electrode for a lithium-containing accumulator.

In an embodiment of the invention, the metal foil is a copper foil. Copper has a very high electrical conductivity and is therefore highly suitable as electrode material. It is also relatively inexpensive and technically easy to handle. Other highly conductive metals such as silver, gold or aluminum are also suitable materials for the metal foil in principle.

In embodiments, electrolytically cleaned copper, which in turn has a purity of at least 99.9%, particularly of 99.99%, is used for producing the copper foil. The electrical conductivity of the copper increases with its purity.

A material which is as pure as possible and of which the crystal structure is as free of faults as possible should also expediently be used for the graphite used. Therefore, a synthetically produced graphite is employed.

Furthermore, the graphite, in order to acquire good coating properties, is provided with a binder and applied in this mixture to the metal foil 6, for example by wet-chemical means. The binder used is for example polyacrylic acid (PAA), acrylate-based copolymers (ACM), styrene-butadiene rubber (SBR) and/or carboxymethylcellulose. In addition, the mixture comprising graphite and binder is for example provided with a conductive additive, in particular with carbon black, for producing the graphite layer.

The nonaqueous electrolyte for example comprises ethylene carbonate, propylene carbonate or dimethyl carbonate, acetonitrile or an ionic liquid. Propylene carbonate is particularly desired here since it is inexpensive to produce and can be used without difficulty. Ionic liquids are salts having a melting point of in particular less than 100° C. Like all salts, they comprise anions and cations. Varying these allows the physicochemical properties of an ionic liquid to be varied over a wide range and optimized to meet the technical requirements. Typical cations may be, for example, imidazolium or pyridinium, ammonium and/or phosphonium. Useful anions include halides and weakly coordinating ions such as tetrafluoroborates or hexafluorophosphates, but also trifluoroacetates and triflates and tosylates.

In an embodiment of the invention, the lithium of the lithium compound in the second electrode includes lithium calcium silicates and/or lithium magnesium silicates and/or lithium manganese oxides and/or lithium cobalt oxides and/or lithium nickel oxides. These are typically compounds which are present in the slag or the ash formed in the thermal breakdown of lithium-ion accumulators.

The operation of embodiments of the method and the operation of the electrochemical cell proceed under inert conditions. A suitable inert gas here is in particular argon. Nitrogen would react with the lithium ions in the nonaqueous electrolyte. A vacuum atmosphere is likewise inefficient owing to the high vapor pressure of the materials used under vacuum conditions.

A constituent of embodiments of the invention is an electrochemical cell for producing an electrode of a lithium accumulator. This electrochemical cell comprises an anode comprising a lithium compound, which originates from for example thermal breakdown of spent lithium accumulators, and a cathode which comprises a metal foil which is provided with a graphite layer on its surface and wherein the anode and the cathode are separated from each other by a nonaqueous electrolyte.

The advantages over the prior art that are possessed by this electrochemical cell have already been explained with regard to the method according to embodiments of the invention. These are firstly the technically uncomplicated, direct reutilization of lithium-containing compounds from the for example thermal breakdown of old accumulators with simultaneous production of a new cathode of a lithium accumulator.

A particularly advantageous configuration of this electrochemical cell is when there are multiple pairs of anodes and cathodes connected in parallel. In this way, upscaling is possible for the production of anodes, and lithium slag from the recyclate of old accumulators can be reutilized on a large scale.

For producing the second electrode, the anode of the electrochemical cell, it is expedient when the lithium compound, i.e., the slag from the thermal breakdown of old accumulators, is mixed with a conductive material, in particular with carbon particles, and then pressed. It is especially preferable here to use porous carbon particles. A pressed electrode of this kind composed of lithium compounds and carbon particles is particularly well suited for use of the electrochemical cell described.

### BRIEF DESCRIPTION

Some of the embodiments will be described in detail, with reference to the following figures, wherein like designations denote like members, wherein:

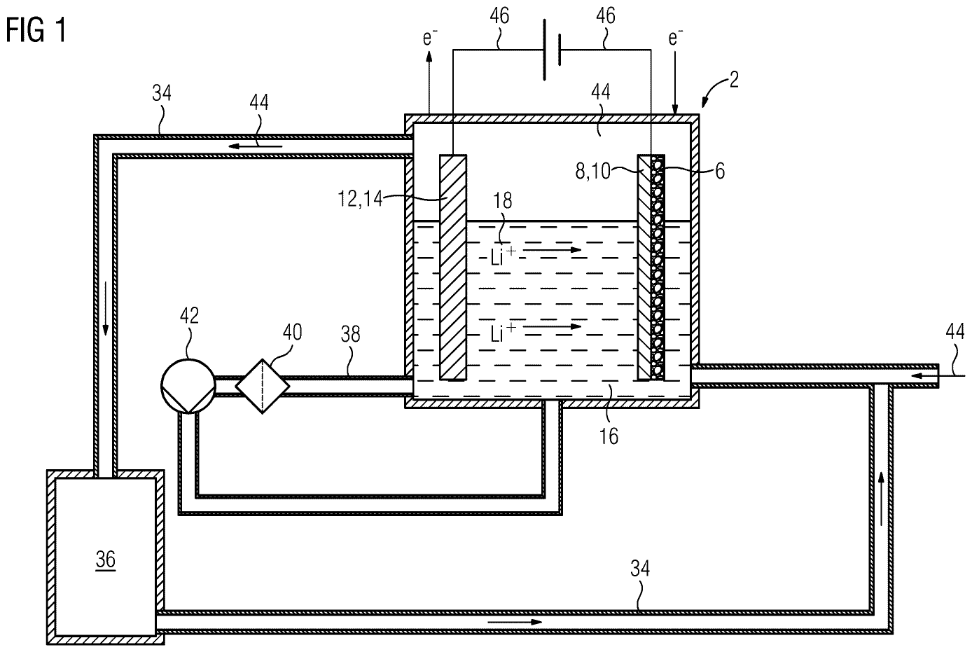

FIG. 1 shows an electrochemical cell for producing a lithium-containing electrode and a corresponding method therefor;

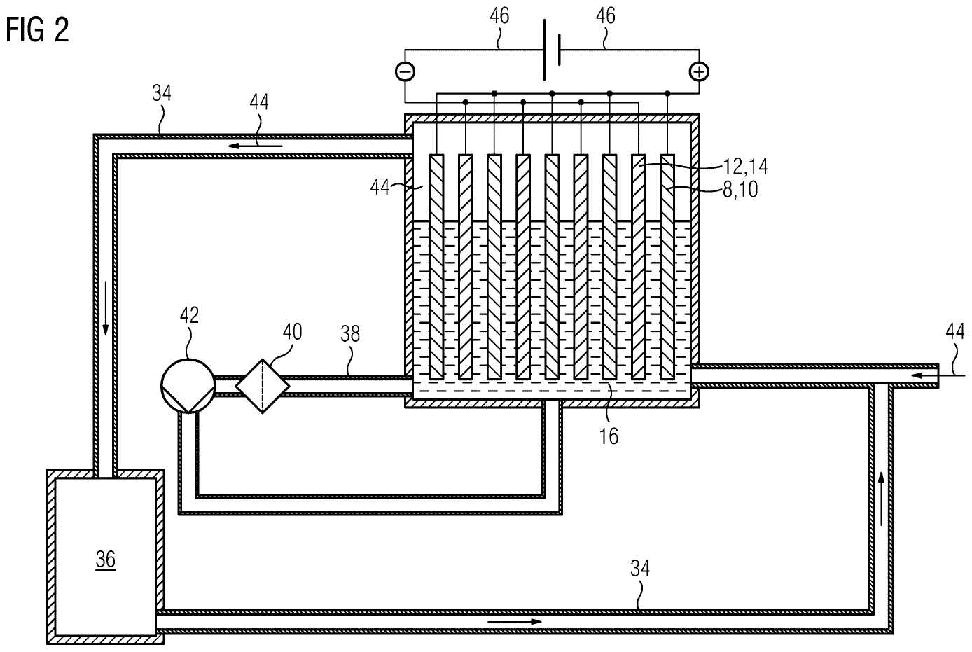

FIG. 2 shows an upscaling version of the electrochemical cell according to FIG. 1;

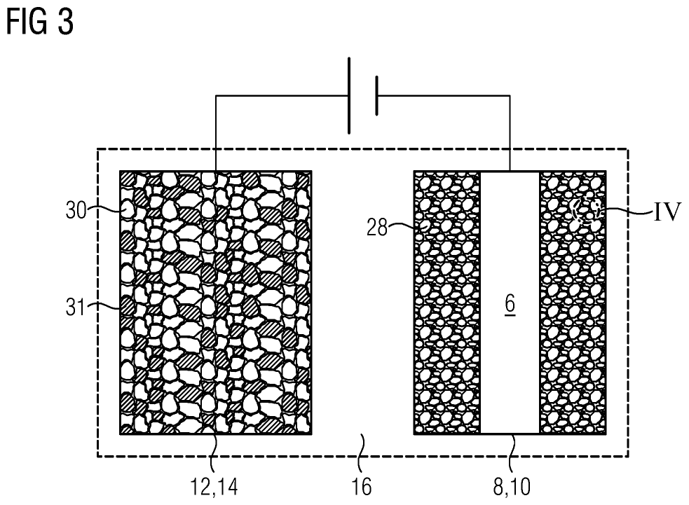

FIG. 3 is a schematic illustration of the electrodes from FIG. 1 for explaining the microstructure; and

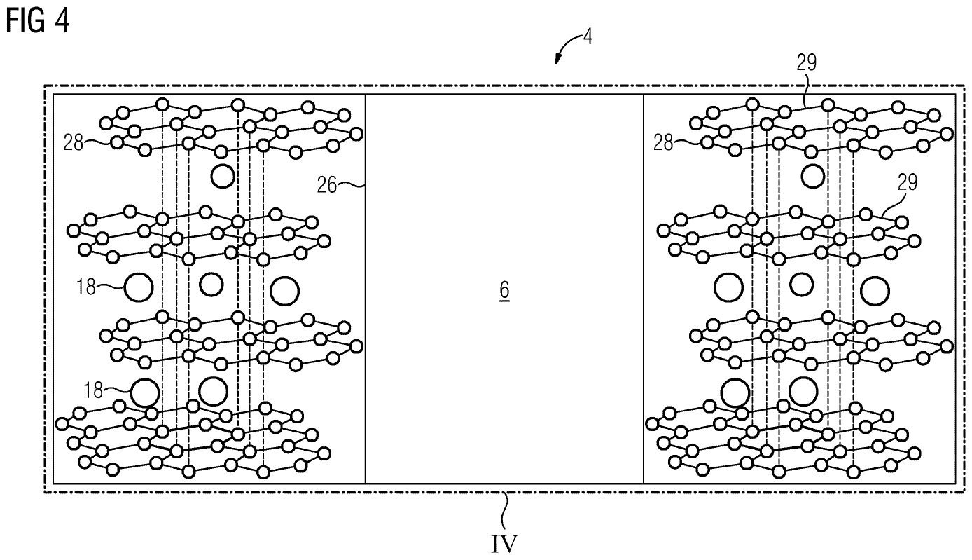

FIG. 4 shows an enlarged detail IV from FIG. 3 for explaining the microstructure.

### DETAILED DESCRIPTION

FIG. 1 gives a schematic description of an electrochemical cell 2 and a method for operating this cell 2. Here, the electrochemical cell 2 comprises a first electrode 8, which is configured as cathode 10. The cell 2 secondly comprises a second, lithium-containing electrode 12, which is configured as anode 14. The two electrodes 8, 12 are immersed in a nonaqueous, liquid electrolyte 16, lithium ions 18, which are identified by Li⁺, migrating from the anode 14 to the cathode 10 in the cell 2 when an electric current is applied via contactings 46. Furthermore, the electrochemical cell 2 is operated under inert gas 44, in this case argon, the inert gas 44 being led off from the cell 2 and being processed in an inert gas circuit 44, there in a gas cleaning system 36, and being fed back to the cell 2. Furthermore, the electrolyte 16 is also processed, for which an electrolyte circulation system 38 is used, this includes a pump 40 and a filter 42. The electrolyte 16 used in this case is a propylene carbonate.

FIG. 2 shows an analogous configuration of the electrochemical cell 2 from FIG. 1, except that a large number of pairs of first electrodes 8 and second electrodes 12, i.e., pairs of cathodes 10 and anodes 14, are connected in parallel in this cell 2. The contacting 46, and also the inert gas circuit 34 and the electrolyte circulation system 38, are configured analogously to the cell 2 in FIG. 1. This configuration according to FIG. 2 serves in particular to achieve upscaling for processing lithium-containing compounds and producing an electrode 4 (cf. FIGS. 3 and 4). The electrochemical process and the preparatory operations for producing the anode 14 and the cathode 10 for the electrochemical cell 2 will be discussed in more detail below.

Since lithium has the lowest standard potential of −3.04 V in the periodic table and is thus the least precious of all elements, electrolytes that dissociate H₃O⁺ ions, i.e., mainly aqueous electrolytes, cannot be used for lithium-containing cells. In an electrochemical deposition, the hydrogen would otherwise be more likely to be deposited than the lithium. The electrochemical window of water is 1.2 V. In this electrochemical potential of the electrode, the electrolyte is neither oxidized nor reduced. This range results from the difference between oxidation potential (anodic limit) and reduction potential (cathodic limit). Outside this range, the electrolyte reacts on the electrode surface. Water is electrolyzed at the same time.

Rather than water, aprotic, polar solvents such as ethylene carbonate, propylene carbonate or dimethyl carbonate, acetonitrile or ionic liquids are used for the deposition of lithium. The organic carbonates and ionic liquids have a larger electrochemical window. In the case of propylene carbonate, the electrochemical window is 4 V, and ionic liquids show a value of 3 V to 6 V. Since the electrochemical window is reduced from 4 V to 2 V by small water inputs (about 3% by weight), it is necessary to work under anhydrous conditions. Moreover, lithium reacts with nitrogen to form lithium nitride and with oxygen to form lithium oxide even at room temperature. Therefore, the electrochemical cell 2 is flushed with inert gas 44, in particular argon or sulfur dioxide. The gas flushing of the cell 2 is performed in the inert gas circuit 34, the inert gas 44 being constantly circulated between the cell 2 and the gas cleaning system 36 and processed continuously. The gas cleaning system 36 removes oxygen and moisture from the inert gas 44 by a copper catalyst and a molecular sieve. Purity levels of down to <1 ppm of O₂ and <1 ppm of H₂O are achieved in this way.

In addition, the electrochemical cell 2 has to be closed off from the environment so that no humidity and no oxygen or nitrogen enters the cell 2. For processing, the electrolyte 16 is likewise pumped constantly through filter systems 42 by a pump 40 and returned to the closed electrochemical cell 2.

For producing the second electrode 12, i.e., the anode 14, a lithium slag, which is obtained during the thermal breakdown of old, spent lithium-ion accumulators, is used. Therefore, this second electrode 12 includes lithium compounds 30, as shown, for example, in FIG. 3. These lithium compounds 30, which can also be referred to as lithium slag because they originate from the thermally decomposed residues from lithium accumulators, contain lithium calcium silicates, lithium magnesium silicates, lithium fluoride and/or lithium aluminite. In the breakdown of particular NMC batteries which contain manganese, depending on the manganese content, the slag also includes lithium manganese oxide (Li₂Mn₂O₃ or the associated spinel type LiMn₂O₄). This lithium slag first has to be mechanically processed by way of crushing the slag and grinding it in a vibratory disk mill or a ball mill to form particles. The powder thus obtained from the slag is then mixed intimately with electrically conductive carbon particles 31 (e.g., electrically conductive carbon black, porous conductive carbon powder or graphite) in a plowshare mixer for battery masses. The mixing drum has a ceramic lining. Mixing elements, mixer shaft and measuring heads are for example provided with a thin, solid, ceramic coating (e.g., aluminum oxide or tungsten carbide), so that extrinsic ions can be avoided. In the plowshare mixer, homogeneous mixing is achieved in a short time. Porous conductive carbon powder in the form of carbon particles 31, for example available under the trade name Porocarb, is particularly highly suitable as an additive for electrode formulation because local regions with high porosity are present after electrode compression.

The macroporous carbon particles 31 are used to improve the ionic conductivity in the electrode 12. As anode degradation progresses, loss of capacity is reduced by the proportion of macropores. Moreover, the mechanical stability of the electrode 12 is increased by the porosity of the particles 31 after compression. The mixed powder (mixture of lithium compound 30 and carbon particles 31) is filled into a press mold and compressed in a pressing operation. This may be uniaxial pressing by a top punch or by isostatic pressing at about 300 bar in an oil bath. In this way, a cylindrical electrode is formed. This second electrode 12 thus produced is inserted as anode 14 into the cell 2.

The associated cathode 10 of the electrochemical cell is already constructed beforehand such that it is converted during the process in the electrochemical cell 2 to an electrode 4 of a lithium accumulator. This means that the cathode 10 in the cell is altered during cell operation such that, at the end of the process, it appears as a new, independent, lithium-containing electrode 4 (cf. FIG. 4). This positive electrode of a lithium accumulator, i.e., the electrode 4, consists of a current collector, the one metal foil 6 and an energy storage layer. This layer is the graphite layer 28 with the lithium ions intercalated therein.

Synthetically produced graphite is for example used for producing the first electrode 8. Synthetic graphite is distinguished from natural graphite by greater purity, better quality and by reproducibility of adapted properties. This leads to a higher cycle stability between charging and discharging operations and to better performance during charging in general. The synthetic graphite is applied with a binder (e.g., polyacrylic acid (PAA), acrylate-based copolymers (ACM), styrene-butadiene rubber (SBR), carboxymethylcellulose, which are soluble in water or ethanol) and a conductive additive (for example carbon black) to a copper foil (metal foil 6). Directly after the wet-chemical application of an electrode slurry, drying is performed in an impact-jet dryer in order to remove the solvent (for example ethanol or water) used. In the impact-jet dryer, the slurry film containing the copper foil is held in suspension and dried as it passes through by jets of air, which strikes the sheet to be dried through a nozzle at high speed and in so doing cause a high heat and mass transfer. This is followed by subsequent drying in a vacuum furnace in order to reduce the residual moisture of water to a few ppm.

The copper foil is an electrolytically cleaned copper, which is drawn to form a foil. The copper cleaned in this way has a very high purity level at >99.99%.

FIG. 3 shows a highly schematic view of a microstructure of the respective electrodes 12, 8 in the cell 2. On the left-hand side, the anode 14 is shown in the form of the second electrode 12. This comprises, as already described, the lithium-containing compound 30, i.e., the processed lithium slag comprising the lithium compounds mentioned. In addition, the structure is provided with conductive carbon particles 31 and compressed to form an electrode 12. The cathode 10 is shown on the right-hand side of FIG. 3. The cathode is the metal foil 6, in this case a copper foil, which is provided with the graphite layer 28 into which the lithium ions 18 are inserted during operation of the cell 2.

FIG. 4 shows the schematic microstructure of the resulting electrode 4, which shows the detail IV from FIG. 3 on an enlarged scale. This electrode 4 is therefore provided with the graphite layer 28, the lithium ions 18 being inserted between the individual graphene layers 29 of the graphite layer 28. This electrode 4 according to FIG. 4 can be used, in principle, to be inserted into a new lithium accumulator, for example as an anode.

In the described method for producing this electrode 4, recycled lithium-containing material is thus used in order to directly produce a new ready-to-use electrode 4 for a new accumulator.

Although the present invention has been disclosed in the form of embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements.
2 electrochemical cell
4 lithium-containing electrode
6 metal foil
8 first electrode
10 cathode
12 second electrode
14 anode
16 nonaqueous electrolyte
18 lithium ions
26 surface of metal foil
28 graphite layer
29 graphene layers
30 lithium compounds
31 carbon particles
34 inert gas circuit
36 gas cleaning system
38 electrolyte circulation system
40 pump
42 filter
44 inert gas
46 contacting

1. A method for producing a lithium-containing electrode for a lithium ion-containing accumulator, the method comprising:
producing a metal foil;
coating a surface of the metal foil with a graphite layer;
introducing the metal foil provided with the graphite layer into an electrochemical cell as a first electrode, which serves as a cathode; and
introducing a second, lithium-containing electrode into the electrochemical cell, the second, lithium-containing electrode serving as an anode,
wherein lithium compounds are introduced into the second, lithium-containing electrode, the lithium compounds originating from decomposed electrode material of a lithium-ion accumulator,
introducing a nonaqueous electrolyte into the electrochemical cell;
closing the electrochemical cell under inert conditions,
applying electric current to the electrodes, of the electrochemical cell, so that lithium ions migrate from the lithium-containing anode to the cathode in a form of the metal foil provided with the graphite layer, through the nonaqueous electrolyte; and
the surface of the metal foil provided with the graphite layer is intercalated to form lithium ions.

2. The method as claimed in claim 1, wherein the metal foil is a copper foil.

3. The method as claimed in claim 2, wherein electrolytically cleaned copper is used for producing the copper foil.

4. The method as claimed in claim 3, wherein the copper has a purity of at least 99.9% or 99.99%.

5. The method as claimed in claim 1, wherein the graphite is a synthetically produced graphite.

6. The method as claimed in claim 1, wherein the graphite is provided with a binder and is applied to the metal foil.

7. The method as claimed in claim 6, wherein the binder comprises polyacrylic acid (PAA), acrylate-based copolymers (ACM), styrene-butadiene rubber (SBR) and/or carboxymethylcellulose.

8. The method as claimed in claim 6 wherein a mixture comprising graphite and the binder is provided with a conductive additive, for producing the graphite layer.

9. The method as claimed in claim 1 wherein the lithium compounds originate from thermally decomposed electrode material of a lithium-ion accumulator.

10. The method as claimed in claim 1, wherein the nonaqueous electrolyte comprises ethylene carbonate, propylene carbonate or dimethyl carbonate, acetonitrile or an ionic liquid.

11. The method as claimed in claim 1, wherein the lithium compound comprises lithium calcium silicates and/or lithium magnesium silicates and/or lithium manganese oxides and/or lithium cobalt oxides and/or lithium nickel oxides.

12. The method as claimed in claim 1, wherein the inert conditions are provided by argon as protective gas.

13. An electrochemical cell for producing an electrode of a lithium accumulator, comprising an anode comprising lithium compounds, which originate from a breakdown of spent lithium accumulators, and a cathode which comprises a metal foil which is provided with a graphite layer on a surface of the metal foil and wherein the anode and the cathode are separated from each other by a nonaqueous electrolyte.

14. The electrochemical cell as claimed in claim 13, wherein the electrochemical cell includes multiple pairs of anodes and cathodes connected in parallel.

15. The electrochemical cell as claimed in claim 13, wherein the lithium compounds are mixed with carbon particles.
